(19) United States
(12) Patent Application Publication
(10) Pub. No.: US 2026/0326267 A1
(43) Pub. Date: Oct. 22, 2026

(54) Wrench and Method of Manufacturing the Same

(71) Applicant: Infar Industrial Co., Ltd., Chang-Hwa (TW)

(72) Inventor: Tai-Hung Chen, Chang-Hwa (TW)

(21) Appl. No.: 19/185,957

(22) Filed: Apr. 22, 2025

(51) Int. Cl. B25B 13/06; B24B 9/00

(52) U.S. Cl. CPC B25B 13/065; B24B 9/00

(57) ABSTRACT

A method of manufacturing a wrench is applicable to perform a deburring process on a to-be-processed product with the shape of a wrench. The to-be-processed product includes an upper end surface, a lower end surface opposing the upper end surface, and a stamped hole extending from the upper end surface to the lower end surface, with burrs located at a junction between the stamped hole and the upper or lower end surface. The method includes the steps of: securing the to-be-processed product in place with a holding jig; and grinding away the burrs using a flat grinding surface of a grinding component. This allows the burrs to be quickly removed without the need to align any components.

### BACKGROUND

### Field of the Invention

The present disclosure relates to wrenches, and more particularly to a wrench and a method of manufacturing the wrench.

### Description of Related Art

Existing wrench manufacturing methods each generally comprise a cutting step, heating step, stamping step, cooling step, and trimming step. The cutting step involves cutting a metallic blank in a coiled cylindrical shape to the appropriate length. The heating step involves performing high-temperature heating on the metallic blank for softening treatment. The stamping step involves using a stamping machine to stamp the metallic blank placed on a die set and softened by high temperature to generate a semi-finished product with the shape of a wrench. The cooling step involves cooling the semi-finished product to shape it. The trimming step involves removing waste material from the entire contour edge of the semi-finished product with a scrap removal machine.

Referring to FIG. 1, a conventional way of removing burrs or removing remaining rough materials from the edge of a plum blossom hole (also known as “socket hole”) of the semi-finished product entails inserting a drill bit A of a cylindrical milling cutter slightly into a plum blossom hole 11 of a semi-finished product 10 fixed to a jig B to remove burrs 12 or remaining rough materials from the semi-finished product 10 and leave a chamfer 13 at the rim of the plum blossom hole 11. As a result, the alignment of the drill bit A with the plum blossom hole 11 of the semi-finished product 10 must be precise in order to ensure the precision of the plum blossom hole of the wrench in terms of shape and dimensions.

However, alignment not only requires additional alignment techniques and equipment, but also tends to result in defective products, leading to increased costs. Moreover, alignment increases the processing time of wrenches, which is not conducive to mass production.

### SUMMARY

It is an objective of the disclosure to provide a wrench and a method of manufacturing the wrench to overcome the issues caused by the need for alignment in the prior art, shorten processing time and reduce manufacturing costs, which facilitates mass production.

To achieve the above and other objectives, there is provided in an embodiment of the disclosure a wrench, including: a wrench body including a grip to be held by a user and a head connected to the grip, the head including a first end surface, a second end surface opposing the first end surface, and a socket hole extending from the first end surface to the second end surface, wherein an inner circumferential surface of the socket hole has a first periphery positioned near the first end surface and a second periphery positioned near the second end surface, the first periphery being perpendicular to the first end surface, and the second periphery being perpendicular to the second end surface.

Optionally, two opposing edges of the inner circumferential surface of the socket hole are collinear with an inner edge of the first end surface and an inner edge of the second end surface respectively.

The disclosure further provides, in an embodiment thereof, a method of manufacturing the wrench, applicable to perform a deburring process on a to-be-processed product with a shape of a wrench, the to-be-processed product including an upper end surface, a lower end surface opposing the upper end surface, and a stamped hole extending from the upper end surface to the lower end surface, with burrs located at a junction between the stamped hole and the upper end surface or the lower end surface, the method including the steps of: securing the to-be-processed product in place with a holding jig; and grinding away the burrs using a flat grinding surface of a grinding component.

The disclosure further provides, in another embodiment thereof, a method of manufacturing a wrench, applicable to perform a deburring process on a to-be-processed product with a shape of a wrench, the to-be-processed product including an upper end surface, a lower end surface opposing the upper end surface, and a stamped hole extending from the upper end surface to the lower end surface, with burrs located at a junction between the stamped hole and the upper end surface or the lower end surface, the method including the steps of: securing the to-be-processed product in place with a holding jig; and grinding away the burrs using a flat grinding surface of a grinding component.

Optionally, the flat grinding surface presses against the to-be-processed product and thus deforms because of the stamped hole to come into contact with an inner lateral side of the stamped hole.

### BRIEF DESCRIPTION OF THE DRAWINGS

The other aspects and advantages of the disclosure are illustrated in the accompanying drawings and further described below.

FIG. 1 is a schematic view of the process flow of removing burrs from a semi-finished product for use in forming a wrench according to prior art.

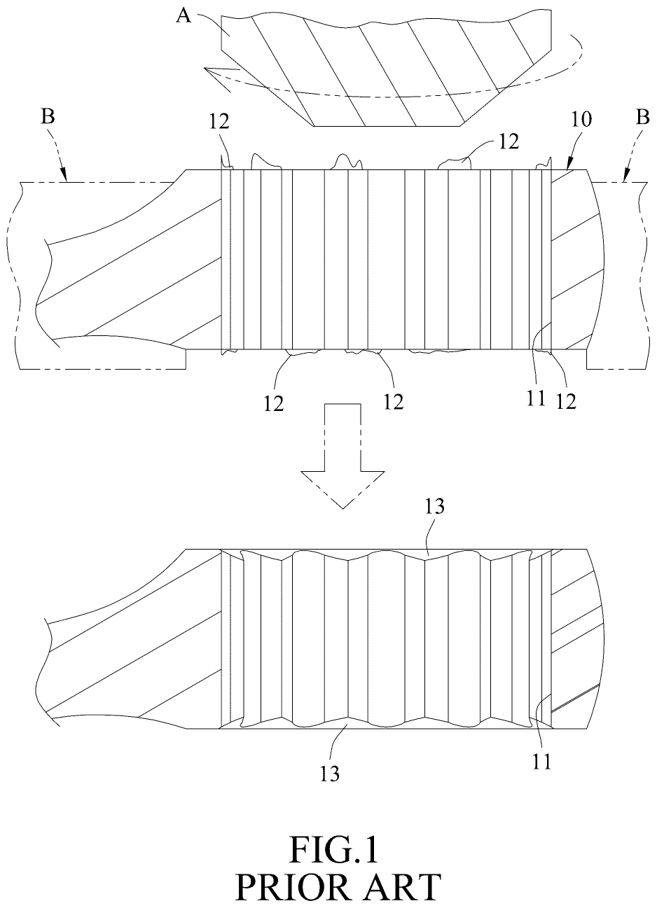

FIG. 2 is a schematic view of the process flow of a method of manufacturing a wrench according to an embodiment of the disclosure.

FIG. 3 is a schematic view of the process flow of a method of manufacturing a wrench, involving removing burrs from a to-be-processed product for use in forming the wrench according to an embodiment of the disclosure.

FIG. 4 is a schematic view of the process flow of a method of manufacturing a wrench, involving removing burrs from a to-be-processed product for use in forming the wrench according to an embodiment of the disclosure.

### DETAILED DESCRIPTION

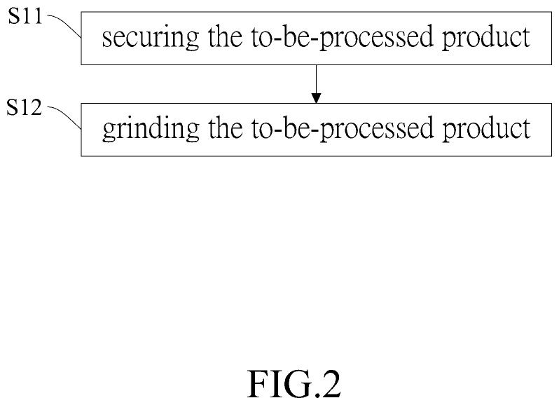

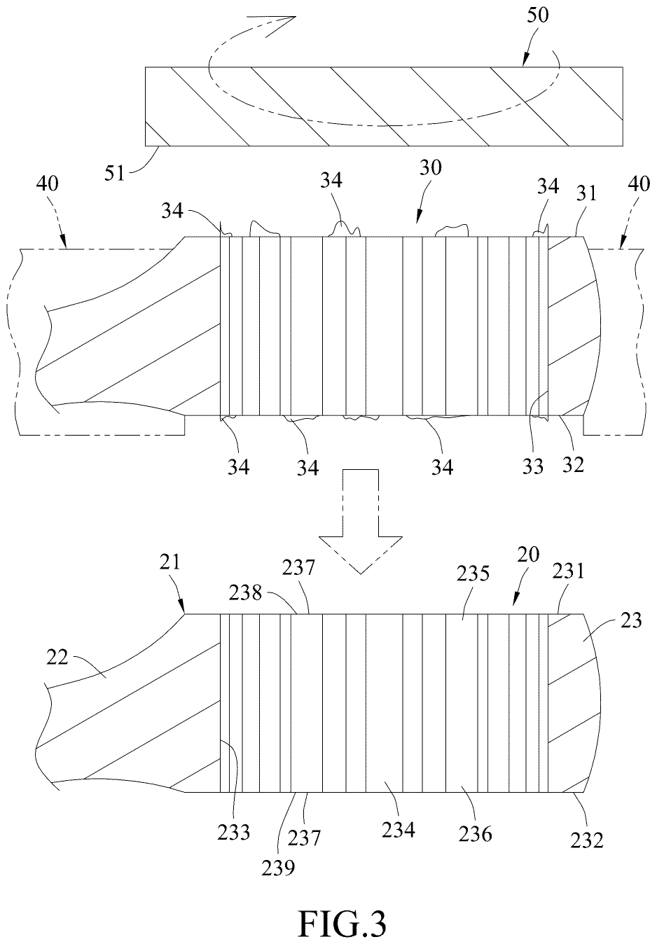

Referring to FIG. 2 and FIG. 3, an embodiment of the disclosure provides a wrench 20 including a wrench body 21. The wrench body 21 includes a grip 22 to be held by a user and a head 23 connected to the grip 22. The head 23 includes a first end surface 231, a second end surface 232 opposing the first end surface 231, and a socket hole 233 extending from the first end surface 231 to the second end surface 232.

Optionally, an inner circumferential surface 234 of the socket hole 233 has a first periphery 235 positioned near the first end surface 231 and a second periphery 236 positioned near the second end surface 232. The first periphery 235 is perpendicular to the first end surface 231. The second periphery 236 is perpendicular to the second end surface 232. Two opposing edges 237 of the inner circumferential surface 234 of the socket hole 233 are collinear with an inner edge 238 of the first end surface 231 and an inner edge 239 of the second end surface 232 respectively.

A method of manufacturing the wrench 20 is exemplarily explained below. The method is applicable to perform a deburring process on a to-be-processed product 30 with the shape of a wrench. The to-be-processed product 30 includes an upper end surface 31, a lower end surface 32 opposing the upper end surface 31, and a stamped hole 33 extending from the upper end surface 31 to the lower end surface 32. Burrs 34 are located at the junction between the stamped hole 33 and the upper end surface 31 and at the junction between the stamped hole 33 and the lower end surface 32. The method includes the steps described below.

Step S11: securing the to-be-processed product 30 in place with a holding jig 40.

Step S12: grinding away the burrs 34 using a flat grinding surface 51 of a grinding component 50.

Therefore, the disclosure allows the burrs 34 to be quickly removed without the need to align the stamped hole 33 of the to-be-processed product 30 with a drill bit of any milling cutter beforehand, effectively reducing processing time, product defect rate, and production costs so as to facilitate mass production.

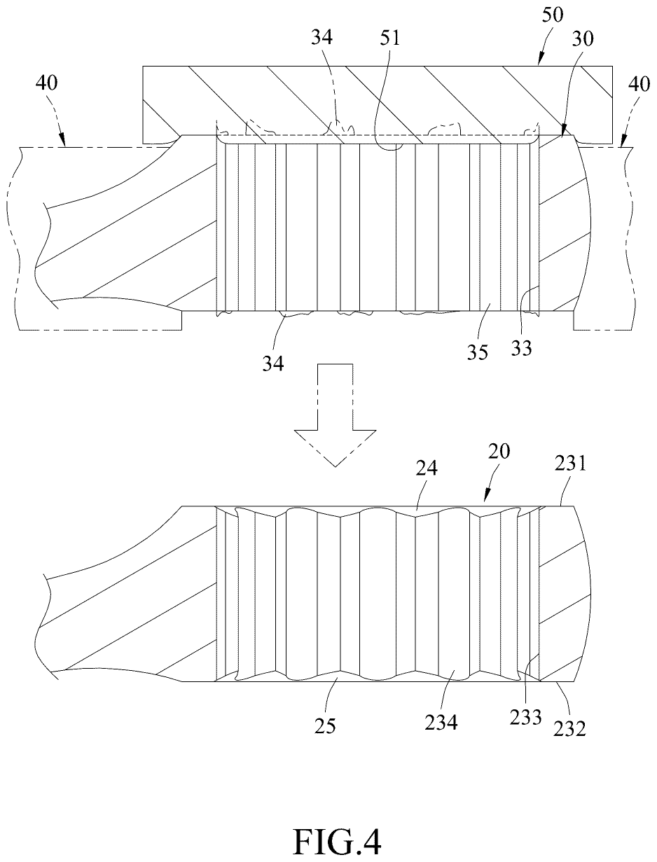

According to the disclosure, the material that the grinding component 50 is made of is appropriately selected to enable the grinding component 50 to have a certain degree of resilience. Thus, as shown in FIG. 4, the flat grinding surface 51 pressing against the to-be-processed product 30 secured in place by the holding jig 40 enters the stamped hole 33 slightly and thus deforms because of the stamped hole 33 to come into contact with an inner lateral side 35 of the stamped hole 33. Therefore, a chamfer 24 is formed at the junction between the first end surface 231 of the wrench 20 and the inner circumferential surface 234 of the socket hole 233, and another chamfer 25 is formed at the junction between the second end surface 232 of the wrench 20 and the inner circumferential surface 234 of the socket hole 233.

Although the disclosure is disclosed above by the aforesaid embodiments, the aforesaid embodiments are not restrictive of the disclosure. Changes, modifications, and combinations of implementation aspects made by persons skilled in the art to the aforesaid embodiments without departing from the spirit and scope of the disclosure must be deemed to fall within the scope of the claims of the disclosure. Accordingly, the legal protection for the disclosure should be defined by the appended claims.

What is claimed is:

1. A wrench, comprising:
a wrench body comprising a grip to be held by a user and a head connected to the grip, and the head comprising a first end surface, a second end surface opposing the first end surface, and a socket hole extending from the first end surface to the second end surface, wherein an inner circumferential surface of the socket hole has a first periphery positioned near the first end surface and a second periphery positioned near the second end surface, with the first periphery being perpendicular to the first end surface, and the second periphery being perpendicular to the second end surface.

2. The wrench of claim 1, wherein two opposing edges of the inner circumferential surface of the socket hole are collinear with an inner edge of the first end surface and an inner edge of the second end surface respectively.

3. A method of manufacturing the wrench of claim 1, applicable to perform a deburring process on a to-be-processed product with a shape of a wrench, the to-be-processed product comprising an upper end surface, a lower end surface opposing the upper end surface, and a stamped hole extending from the upper end surface to the lower end surface, with burrs located at a junction between the stamped hole and the upper end surface or the lower end surface, and the method comprising the steps of:
securing the to-be-processed product in place with a holding jig; and
grinding away the burrs using a flat grinding surface of a grinding component.

4. A method of manufacturing a wrench, applicable to perform a deburring process on a to-be-processed product with a shape of a wrench, the to-be-processed product comprising an upper end surface, a lower end surface opposing the upper end surface, and a stamped hole extending from the upper end surface to the lower end surface, with burrs located at a junction between the stamped hole and the upper end surface or the lower end surface, and the method comprising the steps of:
securing the to-be-processed product in place with a holding jig; and
grinding away the burrs using a flat grinding surface of a grinding component.

5. The method of manufacturing the wrench according to claim 4, wherein the flat grinding surface presses against the to-be-processed product and thus deforms because of the stamped hole to come into contact with an inner lateral side of the stamped hole.
